(19) United States
(12) Patent Application Publication
(10) Pub. No.: US 2022/0274268 A1
(43) Pub. Date: Sep. 1, 2022

(54) Concentric Pre-Curved Bellows Actuators and Related Systems and Methods

(71) Applicant: University of Tennessee Research Foundation, Knoxville, TN (US)

(72) Inventors: Daniel Caleb Rucker, Knoxville, TN (US); Jake A. Childs, Kingston, TN (US)

(21) Appl. No.: 17/627,314

(22) PCT Filed: Aug. 14, 2020
(86) PCT No.: PCT/US2020/046294

§ 371 Date: Jan. 14, 2022

Related U.S. Application Data
(60) Provisional application No. 62/886,714, filed on Aug. 14, 2019.

(51) Int. Cl. B25J 18/06; B25J 15/12; B25J 9/14; B25J 18/00

(52) U.S. Cl. CPC B25J 18/06; B25J 15/12; B25J 9/142; B25J 18/005

(57) ABSTRACT

Mechanical bending actuators are provided including a first concentric, pre-curved bellows; and a second concentric, pre-curved bellows nested inside the first concentric, pre-curved bellows to provide a concentric, pre-curved bellows pair that when rotated axially at a base of the first and/or second concentric, pre-curved bellows provides independent control of a curvature and bending plane of the concentric, pre-curved bellows pair.

### CLAIM OF PRIORITY

The present application claims priority to U.S. Provisional Application Ser. No. 62/886,714, filed on Aug. 14, 2019, entitled Concentric Pre-curved Bellows: New Bending Actuators for Soft Robots, the disclosure of which is hereby incorporated herein by reference as if set forth in its entirety.

### STATEMENT OF GOVERNMENT SUPPORT

This invention was made with government support under Grant. No. U.S. Pat. No. 1,652,588 by the National Science Foundation. The government has certain rights in the invention.

### FIELD

The inventive concept relates generally to actuators and, more particularly, to use of concentric pre-curved bellows as actuators.

### BACKGROUND

Soft and continuum robots have shown great promise for a variety of applications. These robots are generally composed of highly deformable matter such as fluids, gels, and elastomers, with soft actuators such as shape memory alloys (SMAs) and soft sensors such as artificial skin with touch and temperature receptors, comprise a new generation of robots that are capable of flexible movements and delicate interactions, Such robots have extensive potential uses in healthcare applications, robotic exploration tasks, and cooperative human assistance. Soft robotic arms, in particular, have several advantages compared to their rigid counterparts, including high manipulability and maneuverability and providing safe interaction with humans.

These robots can be actuated by a variety of actuation schemes, which could broadly be categorized as either fluid, for example, pneumatic and hydraulic; mechanical, for example, tendons/cables, push-pull rods, and concentric pre-curved tubes; or material-based, for example, piezo-electric, electroactive polymers, and the like. Almost all of these actuation strategies have been used across a wide range of applications and physical scales, from surgical tools with diameters less than a few millimeters to arms greater than ten centimeters in diameter. However, the actuation paradigm of rotating pre-curved concentric tubes has been notably absent from the development of larger-scale soft or continuum robots.

Typical concentric tube robots use relatively “hard” materials, such as Nitinol (although slightly larger and softer concentric tube robots have been made using three-dimensional (3D) printing with semi-flexible materials) and have diameters of a couple of millimeters at most. One reason for this is that bending range of tubes decreases at large diameters (less slender aspect ratios) due to material strain limits. Another reason is that the flexural rigidity of solid tubes increases rapidly with diameter, thus, generally requiring much larger actuation torques to rotate the pre-curved tube bases and bend the tubes. Finally, torsional flexibility and frictional hysteresis continue to be difficult aspects of concentric-tube actuation regardless of robot size. Torsional flexibility can introduce undesired complexities into the behavior of these robots, including, for example, non-constant curvature shapes and “snapping” behavior in which the robot can rapidly release stored elastic energy and transition to a different configuration. Torsional flexibility also allows static friction to affect the robot configuration in a hysteretic way, further complicating modeling and control.

A key design parameter affecting the behavior of concentric pre-curved tubes is the ratio of effective flexural rigidity, EI, to effective torsional rigidity, GJ, referred to herein as the ratio EI/GJ, where E is Young's modulus; I is the cross sectional second moment of area; G is the shear modulus; and J is the polar moment of area. Lowering this ratio can mitigate or eliminate undesired torsional effects. Cutting a pattern of notches into the tubes, i.e. patterning, can reduce the effective flexural to torsional rigidity ratio, and a variety of notch patterns have been investigated. As shown in Table I below, while solid tubes have a ratio of around 1.3 (assuming Poisson's ratio v=1:3), the various notch patterning strategies create tubes with EI/GJ ratios ranging from 0.344 to 0.95. Thus, actuators with improved EI/GJ ratios may be desired.

### SUMMARY

Some embodiments of the inventive subject matter provide mechanical bending actuators including a first concentric, pre-curved bellows; and a second concentric, pre-curved bellows nested inside the first concentric, pre-curved bellows to provide a concentric, pre-curved bellows pair that when rotated axially at a base of the first and/or second concentric, pre-curved bellows provides independent control of a curvature and bending plane of the concentric, pre-curved bellows pair.

In further embodiments, a ratio of EI/GJ, flexural rigidity (EI) to torsional rigidity (GJ), of the concentric, pre-curved bellows pair is less than 0.08. In certain embodiments, the mechanical bending actuator may not exhibit no torsional lag during actuation.

In still further embodiments, a diameter of the concentric, pre-curved bellows pair may be greater than 5 mm.

In some embodiments, rotation of the base of the first and second concentric, pre-curved bellows in equal amounts in opposite directions changes a bending angle in a single plane.

In further embodiments, rotation of the base of the first and second concentric, pre-curved bellows in equal amounts in a same direction changes a plane of bending.

In still further embodiments, the concentric, pre-curved bellows pair may be one of a helical bellows pair and a revolute bellows pair.

In some embodiments, the mechanical actuator may be used in one of soft robots and medical tools.

Further embodiments of the present inventive concept provide systems for actuating a soft robot including pre-curved, concentric bellows actuator, the pre-curved concentric bellows actuator including at least two concentric, pre-curved bellows, the at least two concentric pre-curved bellows comprising a first concentric, pre-curved bellows and a second concentric, pre-curved bellows coupled to the first concentric, pre-curved bellows; and an actuation module coupled to the pre-curved, concentric bellows actuator and configured to provide instructions to the pre-curved, concentric bellows actuator rotate axially at a base of the first and/or second concentric, pre-curved bellows to provide independent control of a curvature and bending plane of the concentric, pre-curved bellows.

Still further embodiments of the present inventive concept provide methods for constructing a robot including pre-curving first and second separate bellows to provide first and second pre-curved bellows; nesting the first and second pre-curved bellows concentrically; and independently rotating bases of the nested first and second pre-curved bellows providing independent control of a curvature and bending plane of the nested first and second pre-curved bellows.

### BRIEF DESCRIPTION OF THE DRAWINGS

FIGS. 1A through 1C are diagrams illustrating various convolutional designs for bellows including a circular convolution (A), a flat convolution (B) and a v-shaped convolution in accordance with various embodiments of the present inventive concept.

FIG. 2A is a diagram illustrating a pair of combined pre-curved concentric bellows in accordance with some embodiments of the present inventive concept.

FIGS. 2B through 2D are diagrams illustrating the pair of combined concentric bellows having different configurations based on the angles thereof in accordance with some embodiments of the present inventive concept.

FIG. 3 is a diagram illustrating convolution geometry and schematic design for bellows in accordance with some embodiments of the present inventive concept.

FIG. 4 is a diagram illustrating convolution geometry and schematic design for revolute bellows in accordance with some embodiments of the present inventive concept.

FIG. 5 is a diagram illustrating convolution geometry and schematic design for helical bellows in accordance with some embodiments of the present inventive concept.

FIGS. 6A through 6C are diagrams illustrating components used to fabricate a pair of pre-curved concentric bellows in accordance with some embodiments of the present inventive concept.

FIGS. 7A through 7C illustrates example experimental set ups for determining flexural rigidity (EI) and torsional rigidity (GJ) of bellows accordance with some embodiments of the present inventive concept.

FIGS. 8A through 8C are graphs illustrating flexural rigidity (A and B) and torsional rigidity (C) calibration results for inner and outer bellows for the revolute bellows design in accordance with some embodiments of the present inventive concept.

FIGS. 9A through 9C are graphs illustrating flexural rigidity (A and B) and torsional rigidity (C) calibration results for inner and outer bellows for the helical bellows design in accordance with some embodiments of the present inventive concept.

FIG. 10 is a diagram illustrating an example manual actuation set up used in model validation experiments in accordance with some embodiments of the present inventive concept.

FIG. 11 is a graph illustrating the angle between the inner and outer bellows at the tip over a range of relative base actuation angles in accordance with some embodiments of the present inventive concept.

FIG. 12 is a diagram illustrating an example experimental set up for measuring points along the curvature of the bellows pair in accordance with some embodiments of the present inventive concept.

FIG. 13 is a diagram illustrating actuated configurations where angles of the inner and outer bellows are equal in magnitude but opposite in direction in accordance with various embodiments of the present inventive concept.

FIG. 14 is a graph illustrating experimental measurements of helical bellows in actuated configurations in comparison with a torsionally-rigid kinematic model using finite element analysis (FEA) determined parameters and using experimentally determined parameters in accordance with some embodiments of the present inventive concept.

FIG. 15 is a graph illustrating a side view of the out-of-plane modeling error in the 180 degree configuration in accordance with some embodiments of the present inventive concept.

FIGS. 16A and 16B are diagrams illustrating payload capacity of a helical concentric pre-curved bellows pair actuated with (A) and without (B) a 100g tip load in accordance with some embodiments of the present inventive concept.

FIG. 17 is a diagram illustrating an example soft gripper demonstration in accordance with some embodiments of the present inventive concept.

FIG. 18 is a diagram illustrating nickel alloy bellows having a relatively small size suitable for surgical applications in accordance with some embodiments of the present inventive concept.

FIG. 19 is a diagram illustrating large bending angles for the nickel alloy bellows illustrated in FIG. 18 in accordance with some embodiments of the present inventive concept.

FIG. 20 is a diagram illustrating pre-curved concentric bellows actuators having more than two bellows in accordance with some embodiments of the present inventive concept.

FIG. 21 is a diagram illustrating a cross section of the bellows assembly illustrated in FIG. 20 in accordance with some embodiments of the present inventive concept.

FIG. 22 is a diagram illustrating a plurality of “bellows” where some number of bellows extends distally further than others, such that individual curved segments are coupled end to end in accordance with some embodiments of the present inventive concept.

FIG. 23 is a diagram illustrating a plurality of “bellows” assemblies coupled end to end each having a co-located motor package (drive mechanism) in accordance with some embodiments of the present inventive concept.

FIG. 24 is a diagram illustrating a bellows pair having a plurality of motors associated therewith in accordance with some embodiments of the present inventive concept.

FIG. 25 is a diagram illustrating a bellows pair having a plurality of motors associated therewith in accordance with some embodiments of the present inventive concept.

FIG. 26 is a block diagram of a data processing system in communication with an actuation module associated with a bellows actuation system in accordance with some embodiments of the present inventive concept.

FIG. 27 is a flowchart illustrating methods for constructing and actuating robots in accordance with some embodiments of the present inventive concept.

### DETAILED DESCRIPTION

Specific exemplary embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like items. It will be understood that when an item is referred to as being “connected” or “coupled” to another item, it can be directly connected or coupled to the other item or intervening items may be present. As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, items, and/or components, but do not preclude the presence or addition of one or more other features, integers, steps, operations, items, components, and/or groups thereof.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

As briefly discussed above, rotation of pre-curved nested tubes is a well-known principle by which needle-sized concentric-tube robots operate, but the concept has not been scaled up to large diameters due to the trade-offs of, for example, increased actuation forces, decreased range of motion, strain limits, and torsional windup. These nested tube actuators include one tube inserted into a second tube. Naturally, these tubes want to align to each other, but for actuation they are forced to misalign. Due to torsional flexibility, a phenomenon known as “snapping” occurs where the tubes unexpectedly snap out of the position into which they are forced, which is not good for system. This problem is particularly present when the tubes are very curved or very long, and this creates a situation where it is difficult to control the tip position, which can cause the robot to be unstable. Various solutions have been discussed to address the snapping issue.

Embodiments of the present inventive concept provide a mechanical bending actuator for soft and continuum robots that may avoid the snapping issue as well as provide additional benefits. As will be discussed further herein, the mechanical bending actuator according to embodiments discussed herein includes a pair of concentric, pre-curved bellows. Each pair of concentric pre-curved bellows, when rotated axially at its base, allows independent control of the curvature and bending plane of the pair of concentric, pre-curved bellows. Using this bellows structure as an actuator instead of conventional pre-curved tubes allows actuation by rotation of pre-curved concentric elements at much larger scales; and torsional lag, i.e., when the relative tube angle at the tip differs from that at the base, and torsional instability are reduced, or possibly virtually eliminated, due to the high ratio of torsional rigidity to flexural rigidity endowed by the bellows geometry in accordance with some embodiments of the present inventive concept.

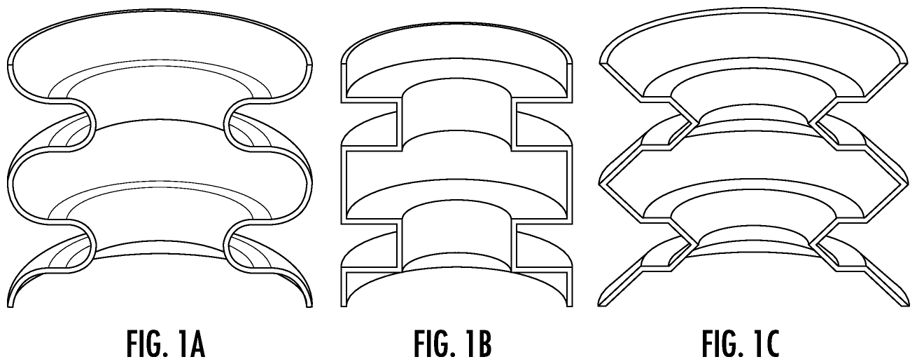

As used herein, a “bellows” generally refers to an instrument or machine that by alternate expansion and contraction draws in air through a valve or orifice and expels it through a tube. However, in some embodiments, bellows, in the context of concentric pre-curved bellows, may refer to thin-walled, tubular structures with a diameter that varies periodically along the length of the tube. A typical bellows design consists of a convolution geometry that is revolved, or helically revolved, around a central axis. Possible convolution geometries are illustrated, for example, in FIGS. 1A through 1C. As illustrated, possible convolution geometries can be designed using circular (FIG. 1A), flat (FIG. 1B), or v-shaped convolutions (FIG. 1C). Bellows can be designed to have elements from any of the or all three variations and can be chosen based upon desired mechanical properties and simplicity in fabrication, depending on the bellows manufacturing method.

Although embodiments of the present inventive concept refer to a pair of concentric pre-curved bellows that are printed using a three-dimensional (3D) printer, it will be understood that embodiments of the present inventive concept are not limited to this configuration. Furthermore, although embodiments of the present inventive concept are discussed herein as being pre-curved in a circular arc, it will be understood that embodiments of the present inventive concept are not limited to this configuration. The pre-curved shape can be any type of curve without departing from the scope of the present inventive concept.

As further used herein, “torsional rigidity” (GJ) refers generally to the amount of resistance a cross section has against torsional deformation. The higher the rigidity, the more resistance the cross section generally has. Torsional rigidity is the force couple required to twist a nonrigid slender structure in one unit of twist angle per unit length. “Flexural rigidity” (EI) refers to the force couple required to bend a fixed non-rigid structure in one unit of curvature or it can be defined as the resistance offered by a structure while undergoing bending.

Embodiments of the present inventive concept address at least two existing short comings of conventional concentric-tube actuation modules. Conventional actuation modules are generally limited to small diameter applications and have torsional compliance limitations. While bellows structures are often used as flexible pressure vessels for fluidic actuation strategies, embodiments of the present inventive concept use a bellows tube itself as a mechanical transmission element by pre-curving two separate bellows, nesting them concentrically, and then independently rotating their bases in a manner similar to pre-curved concentric-tube robots.

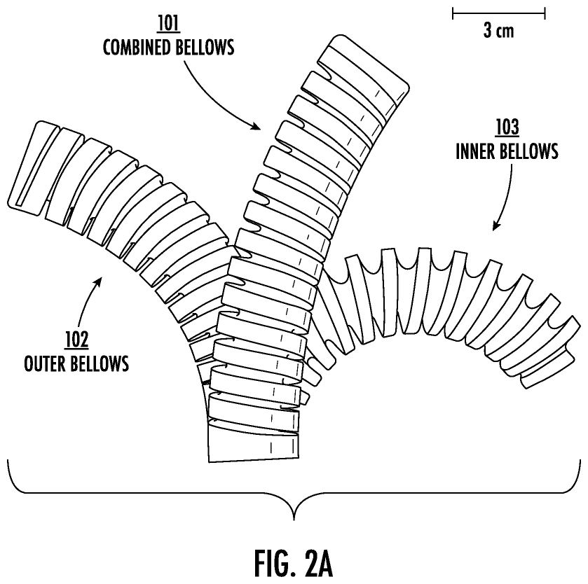

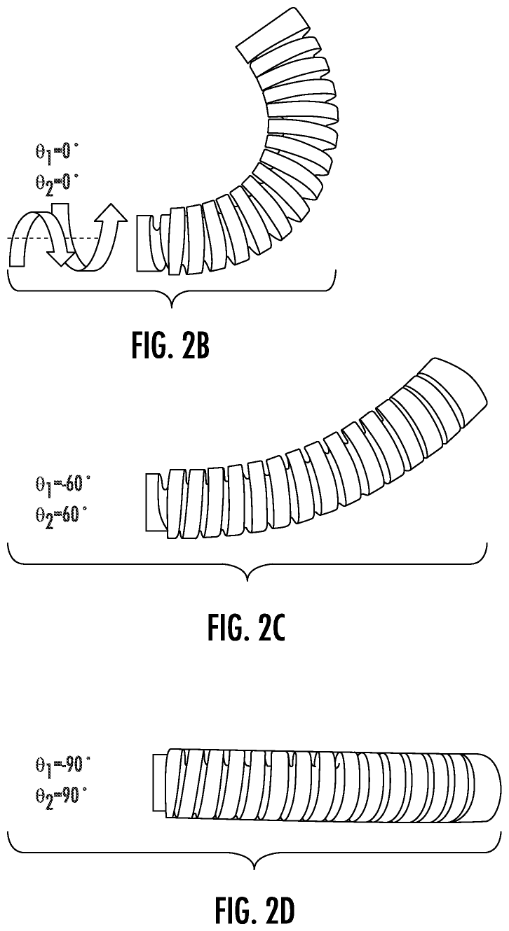

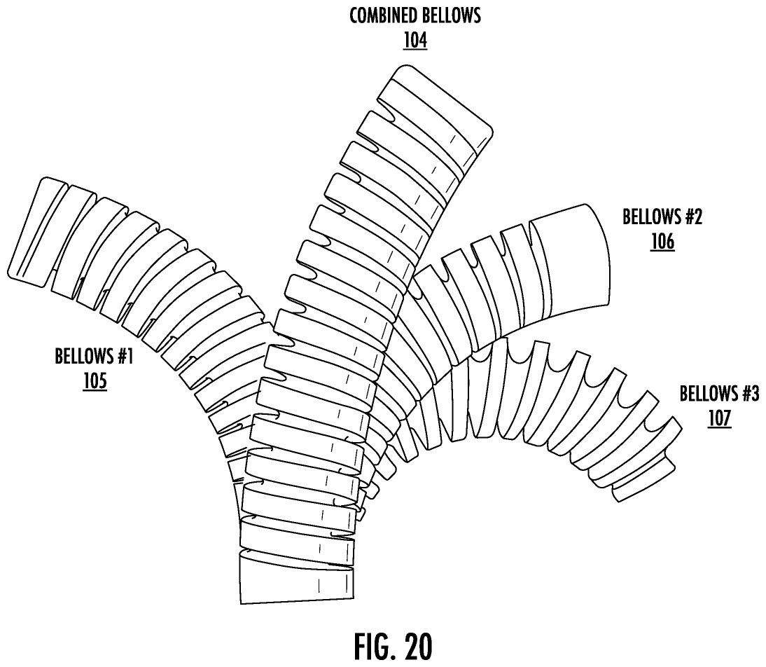

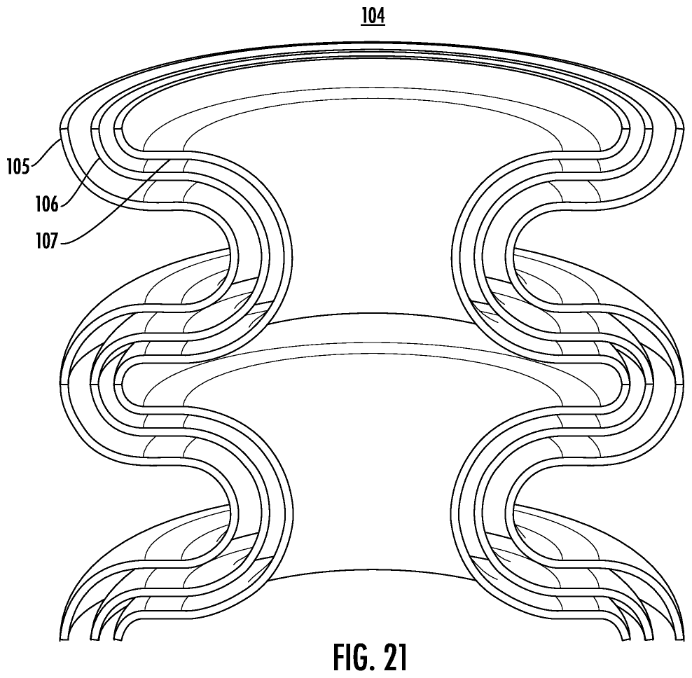

Some embodiments of the present inventive concept are used to provide bending actuation via axial rotation of concentrically nested, pre-curved bellows. A pair of concentric pre-curved bellows, consisting of an inner and outer bellows tube nested within one another as shown in FIG. 2A, enables independent control of resultant curvature and bending plane of the combined bellows pair as will be discussed further below with respect to FIGS. 2A through 2D. It will be understood that although FIGS. 2A through 2D illustrate two nested bellows, embodiments of the present inventive concept are not limited to this configuration. Pre-curved, concentric bellows actuators in accordance with embodiments discussed herein may have two more bellows as discussed below with respect to, for example, FIG. 20, without departing from the scope of the present inventive concept.

A concentric pre-curved bellows pair in accordance with embodiments of the present inventive concept is illustrated, for example, in FIG. 2A. FIG. 2A illustrates the combined bellows 101, the outer bellows (i.e., an interior bellows inserted in an exterior bellow) 102 and inner bellows 103 (i.e. the exterior bellows having the interior bellows inserted (nested) therein). As illustrated in FIG. 2A, a range of bending angles in a single plane can be achieved by rotating bases of the outer bellows 102 and/or the inner bellows 103 by the same angle in opposite directions if the bellows have equal flexural rigidities. The plane of bending can be changed by rotating the bellows bases equal amounts in the same direction. In other words, the equilibrium curvature for the pair of concentric bellows is determined by the pre-curvature and flexural rigidity of each of the individual bellows. The concentric bellows pair 101 is actuated by axially rotating the base of each individual bellows 102, 103. Rotating equal amounts in opposite directions changes the bending angle in a single plane, while rotating equal amounts in the same direction changes the plane of bending. Torsional rigidity is high relative to flexural rigidity due to the bellows geometry. Various angles for the pair of pre-curved concentric bellows pairs 101 are illustrated in FIGS. 2B through 2D. These figures are provided as examples only and, therefore it will be understood that embodiments of the present inventive concept are not limited thereto. For example, in FIG. 2B, both the outer bellows 102 (θ₁) and inner bellows 103 (θ₂) are rotated to 0 degrees. In FIG. 2C the outer bellows 102 (θ₁) and inner bellows 103 (θ₂) are rotated to −60 degrees and +60 degrees, respectively, and in FIG. 2D the outer bellows 102 (θ₁) and inner bellows 103 (θ₂) are rotated to −90 degrees and +90 degrees, respectively. It will be understood there many other combinations of angles that can be achieved without departing from the scope of the present inventive concept.

As illustrated in FIGS. 2A through 2D, the geometry of typical convolution bellows designs exhibits high torsional rigidity (GJ) relative to flexural rigidity (EI) which may virtually eliminate negative effects associated with torsion. As will be discussed further below with respect to Tables I through III, concentric pre-curved bellows pairs in accordance with embodiments discussed herein exhibit experimental EI/GJ values between 0.016 and 0.078 (see Table I), which is (1) an order of magnitude lower than typical EI/GJ values achieved so far through laser machined cutout patterns; and (2) low enough to effectively eliminate any torsional lag during actuation, such that simple torsionally rigid kinematic models become accurate and stable operation of the actuator can be achieved even at high curvatures. Furthermore, concentric pre-curved bellows pairs as discussed herein, exhibit a large bending range of motion within reasonable material strain limits. This aspect of the present inventive concept may enable fabrication of large diameter robots (for example, greater than 5 mm in diameter) and may allow for large pre-curvatures relative to the bellows diameter. The bellows geometry is not as compact as thin-walled tubes since the bellows convolutions alternate between two different inner and outer diameters and, therefore, it may be challenging to scale the concentric-bellows down to extremely small diameters. However, for larger, soft robotics applications the concentric bellows is an alternative to other methods, such as tendon-based, or fluidic actuation. For embodiments of the present inventive concept, in contrast to tendon-driven robots, friction generally does not affect the shape much, even at large bending angles. Reliability, safety, and precision are also benefits due to the simple mechanical nature of the actuation.

TABLE 1

| Design | EI/GI |
|---|---|
| Solid Tube | 1.3 (if v = .03) |
| Horizontal Notches (120°) | 0.4 |
| Horizontal Notches | 0.48 |
| Horizontal Notches (120°) | 0.344 to 0.587 |
| Cellular Hole Pattern | 0.94 |
| Bellows Tube | 0.016 to 0.078 |

### Flexural to Torsional Rigidity Ratios

Although some embodiments of the present inventive concept provide details associated with design and fabrication of three-dimensional (3D) printed pairs (fused-deposition modeling) of pre-curved concentric bellows, it will be understood that embodiments of the present inventive concept are not limited to this configuration. Other methods and materials may be used, (for example, electroforming), without departing from the scope of the present inventive concept.

### Convolutional Design

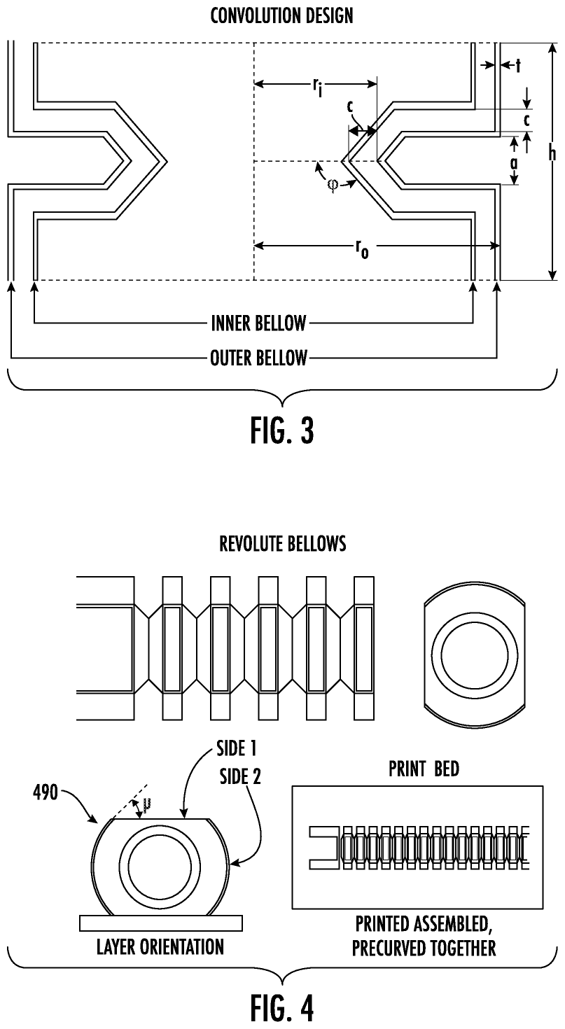

A typical bellows design consists of a convolution geometry as, for example, illustrated in FIG. 3 that is revolved around a central axis to form a “revolute bellows” (FIG. 4). For 3D printing, a v-shaped inner geometry and a flat outer geometry may be used, as shown in FIG. 3, to reduce, or possibly minimize, overhangs and provide a stable interface with the print bed of the 3D printer. The plate width, i.e., the difference between a bellows inner (rᵢ) and outer radii (rₒ), and the wall thickness are the dominant factors in influencing the flexural rigidity, while the overall diameter is relatively less significant (in contrast to solid tubes). This enables an inner/outer balanced stiffness pair of bellows to be designed. In embodiments illustrated in FIG. 3, the inner bellows may be just slightly stiffer than the outer bellows because it has a smaller plate width and the same wall thickness. As illustrated in FIG. 3, there are various measurements that may affect the bellows: Inner radius, rᵢ; Outer radius rₒ; Wall thickness t; Clearance c; Convolution Pitch h; Convolution gap a; Inner Convolution Angle ϕ; and Tangent angle at cut μ. These variables will be discussed further below, for example, with respect to Table II. However, it will be understood that various convolutional geometries may be used without departing from the scope of the present inventive concept. For example, FIGS. 1A through 1C illustrate three convolutional geometries that may be used alone or in combination as discussed above.

### Revolute Bellows

Revolving an inner and outer convolution geometry about a central axis results in a concentric pair of revolute bellows that generally cannot be assembled or disassembled because they are interlocked. One way to construct such an assembly is to additively manufacture the two bellows tubes simultaneously in the assembled (interlocked) state, as illustrated for example in FIG. 4. While dissolvable support material can be used to support and separate the two bellows surfaces during printing, it is very challenging to subsequently dissolve the support material due to the winding convolution geometry and small clearance between the parts. To reduce the likelihood of this difficulty, an extruded cut (see 490), which makes an angle μ from the outer tangent, can be applied to either side of the assembled bellows as shown in FIG. 4. The geometry of each individual bellows can then be independently anchored to the build plate, and the pair can be printed in the assembled state without support material.

### Helical Bellows

It is also possible to create a bellows tube geometry by specifying a helical extrusion of the convolution geometry (with pitch h) instead of a revolved extrusion. This allows easy assembly and disassembly of a bellows tube pair by simply threading them into or out of each other. In other words, in embodiments using helical bellows, the pair of concentric bellows does not have to be printed in the interlocked state. Thus, individual helical bellows can be printed (or manufactured by some other method) and pre-curved separately and subsequently assembled. Actuation of a helical bellows pair may be achieved by combined translation and rotation of each base with pitch h.

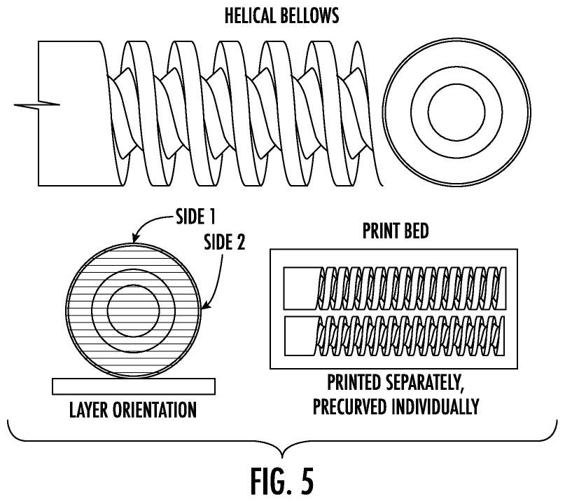

Thus, convolution geometry schematic and design parameters illustrated in FIG. 3 may be used for revolute (FIG. 4) and helical bellows (FIG. 5). 3D printing layer orientation along with side references used in parameter estimation and kinematic experiments are shown for both revolute and helical bellows. As discussed above, a revolute bellows (FIG. 4) pair cannot be disassembled and must be printed and pre-curved in the assembled state. Helical bellows (FIG. 5) can be printed and pre-curved separately and subsequently assembled

### Pre-Curving Via Heat Treatment

After either a revolute bellows pair (FIG. 4) or an individual helical bellows (FIG. 5) is printed, the bellows can be pre-curved by constraining it to a desired shape via, for example, using a jig, and heating it to the glass transition temperature of the material. The glass transition temperature of the material refers to the gradual and reversible transition in amorphous materials (or in amorphous regions within semi-crystalline materials) from a hard and relatively brittle “glassy” state into a viscous or rubbery state as the temperature is increased. An amorphous solid that exhibits a glass transition is called a glass. The reverse transition, achieved by supercooling a viscous liquid into the glass state, is called vitrification.

Thus, the jig is inserted into the bellows, heated to the glass transition of the material and, after glass transition, the bellows including the jig is allowed to cool in its fixed pre-curved state. Once the bellows is cooled, the jig may be removed, and the bellows may maintain the curved shape. In some embodiments, it may be possible to eliminate the heat treatment step by simply printing the concentric bellows pair in the pre-curved state, but this may require more effort and complexity in the computer aided design (CAD) modeling of the design.

It will be understood that methods of pre-curving discussed above are associated with embodiments including a polymer material. Those of skill in the art will understand that shape setting for other materials, such as metals, may not be the same as for polymer materials. For example, shape setting for metals may involve cold working, hot working, and annealing. The process for Nitinol is referred to as shape setting and is a well-known process.

### Example Bellows Specifications and Fabrication

The dimensions of the bellows in accordance with some embodiments of the present inventive concept for both revolute and helical designs are tabulated and provide in Table II below. These dimensions are provided for example only and were selected iteratively such that bellows could smoothly rotate within one another and feasibly be fabricated. Prototypes were 3D printed out of Polylactic Acid (PLA) material on a Makerbot Replicator 2 at 230° Celsius (C) and a layer height of 0.15 mm. PLA is a widely used plastic filament material in 3D printing and includes polyester. Single wall (shell) print settings with no infill and a floor/ceiling height of 0.4 mm were used to achieve a finished part with roughly uniform wall thickness. It will be understood that although these parameters were used to make prototypes for experimentation discussed herein, embodiments of the present inventive concept are not limited thereto.

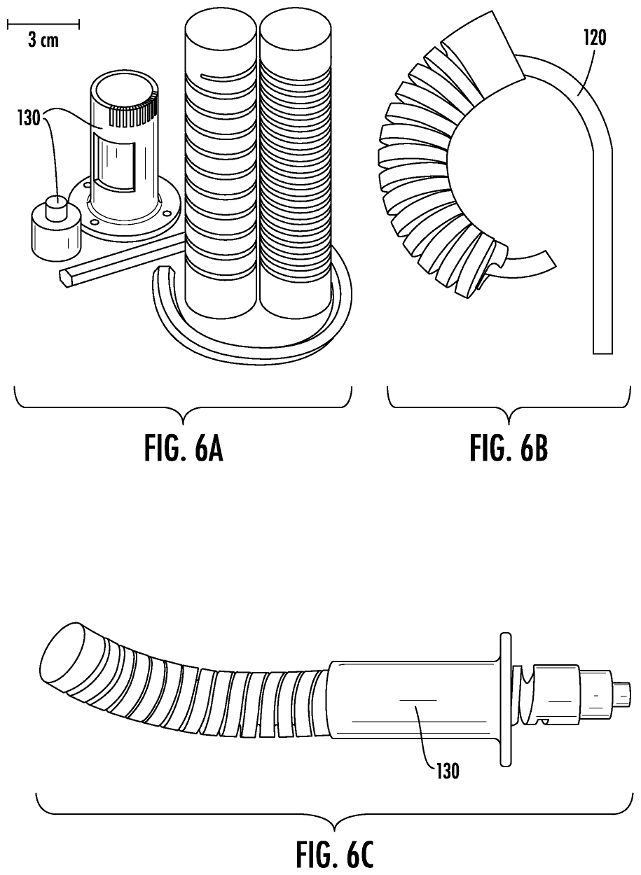

As illustrated in FIGS. 6A through 6C, a curvature jig 120 is inserted through the bellows inner lumen (inner open space or cavity of a tube) to enforce a desired pre-curvature on the bellows as shown in FIG. 6B. In some embodiments, to increase the likelihood, or possibly ensure, that the shape of the jig 120 is maintained through the heating process the jigs are printed using a material having a higher glass transition temperature than the material for the bellows. For example, in some embodiments, the jig 120 may be made of a co-polyester material, for example, ColorFabb HT with a higher glass-transition temperature greater than the bellows material, for example, PLA as discussed above. The jig-constrained bellows (jig inserted in the bellows—FIG. 6B) are heated, for example, placed in an oven (Quincy Lab Model 10 Oven) at 60° C. for 20 minutes. After heating, the bellows are ambiently (allowed to cool without refrigeration) cooled to room temperature (approx. 24° C.) while leaving the curved jig 120 within the bellows for at least 20 minutes. After removal of the jig 120, the inner and outer pre-curved bellows are each connected to a drive mechanism 130 (actuation system), shown in FIGS. 6A (disassembled) and 6C (assemble), which allows coupling to a manual actuation system which axially rotates and translates the bases of each of the bellows as discussed further below.

TABLE II
Bellows Dimensions of 3D Printed Embodiments
Used in Kinematic and Bending Experiments

| Parameter | Value |
|---|---|
| Inner radius, rᵢ | 7.5 mm |
| Outer radius, rₒ | 15 mm |
| Wall thickness, t | 0.3 mm |
| Clearance, c | 1.2 mm |
| Convolution Pitch, h | 9 mm |
| Convolution gap, a | 2.5 mm |
| Inner Convolution Angle, ϕ | 135° |
| Tangent angle at cut, μ | 45° |

### Parameter Calibration

In order to develop accurate kinematic (aspects of motion apart from considerations of mass and force) models and predict concentric-tube manipulator performance, the effective flexural and torsional rigidities of a bellows design was calculated. As discussed below, embodiments of the present inventive concept calibrate model parameters for prototype bellows by fitting the rigidity parameters to deflection data from small-deflection loading scenarios. Calibrations may be compared using data from (1) FEA simulations of the bellows; and (2) experimental tests on the physical prototypes. These parameters may ultimately be used in a constant-curvature kinematic model discussed below.

FEA refers to a computerized analysis method use to envisage how a manufactured product will react to the physical world. The analysis generally includes bringing the product in contact with force, heat, vibration, fluid flow and other such physical conditions. Although embodiments of the present inventive concept are discussed herein as using FEA simulations, embodiments of the present inventive concept are not limited to this configuration.

### Calibration Setups

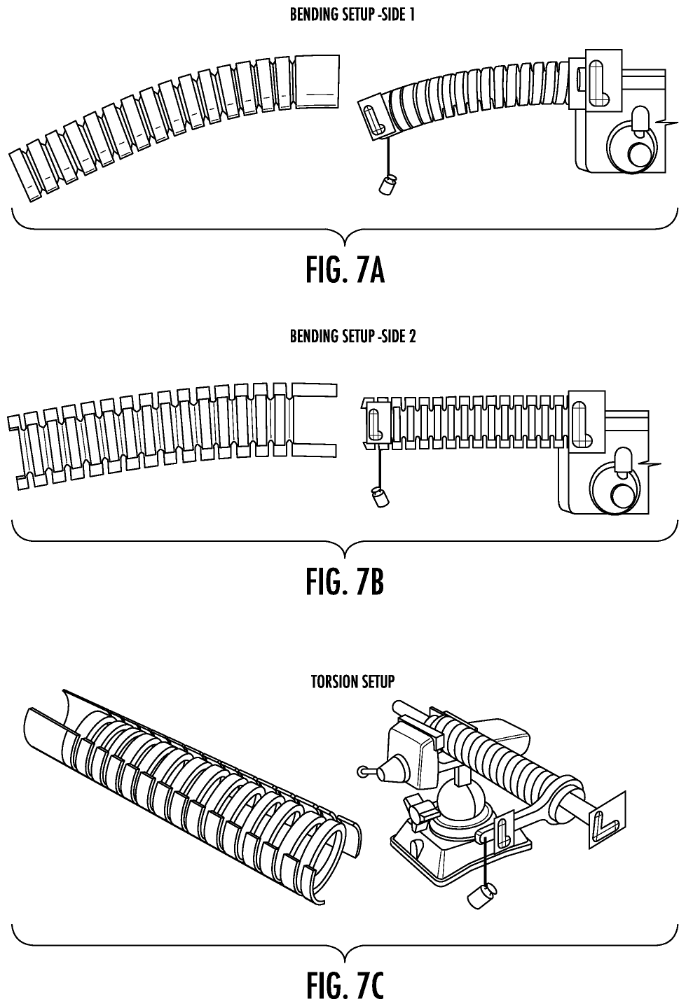

The FEA simulations were produced using Abaqus/Standard (Simulia, Dassault Systems). Each bellows design was modeled using quadrilateral shell elements (element type S4R) with a thickness of 0.3 mm. Young's modulus for 3D printed PLA can vary between 1.8 to 3.3 GPa based on a variety of material factors and testing standards. For FEA simulations, a Young's modulus of 3.15 GPa was used. Typical simulation run time was about 10 seconds. The experimental setup used a stereoscopic camera (ClaroNav Microntracker H3-60) and markers attached to the bellows prototypes to measure tip deflections and rotations from bending and torsion experiments as shown in FIGS. 7A through 7C. In particular, FEA and experimental setups for side 1 and side 2 as well as torsional are shown in FIGS. 7A through 7C.

### Fitting the Flexural Rigidity

To determine the effective flexural rigidity, a range of tip loads were applied at the distal bellows end and the deflection was measured. In some embodiments, the max tip load is 5 grams in order to remain in the small deflection range. The effective flexural rigidity EI was then fitted to the small deflection data using the Euler-Bernoulli tip deflection formula.

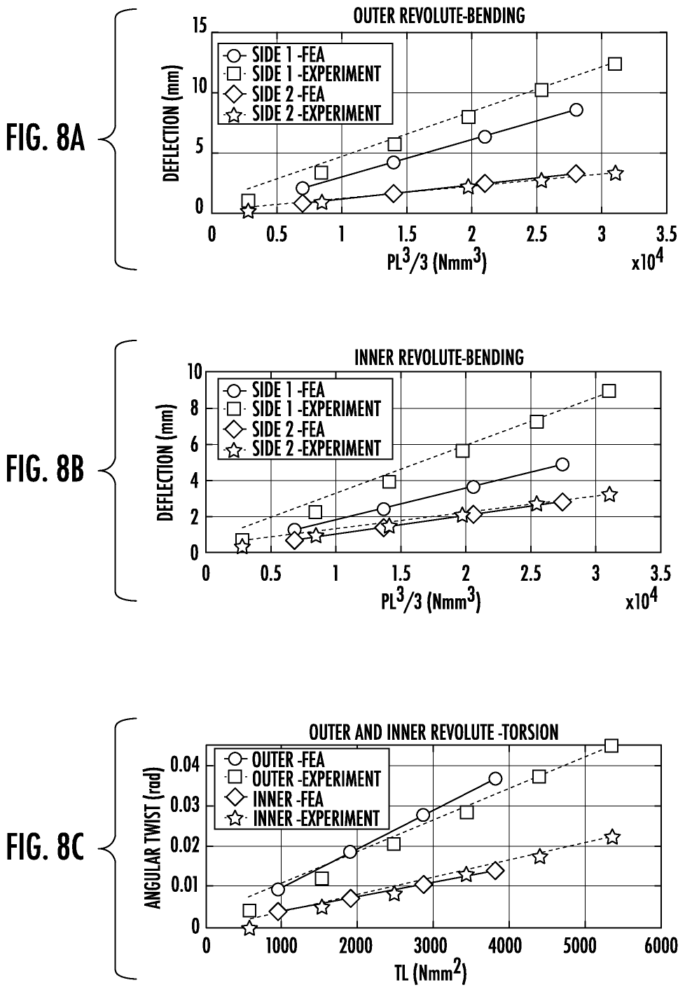

ω=PL³/3EI Eqn. (1)

where co is the tip deflection; P is the tip load; and L is the length of the beam. The deflection data and the linear fit is plotted as shown in FIGS. 8A-C and 9A-9C. In the FEA trials, tip masses of 1, 2, 3, and 4 grams were applied to the distal end while the experimental trials include an additional 5 gram load as well as the mass of the tip marker. These trials were performed with loads applied in the direction of Sides 1 and 2 for both the revolute and helical designs discussed above. After linearly fitting deflection data versus PL³/3, the slope of this fitted line then corresponds to 1/EI, the inverse of the estimated flexural rigidity (EI). The linear fit R-squared values for all flexural rigidity trials were at least 0.99 or greater.

### Fitting Torsional Rigidity

The effective torsional rigidity (GJ) was estimated by measuring the angular twist of the bellows φ from an applied torsional load T to a bellows of length L. The twist angle can be calculated as follows:

φ=TL/GJ Eqn. (2)

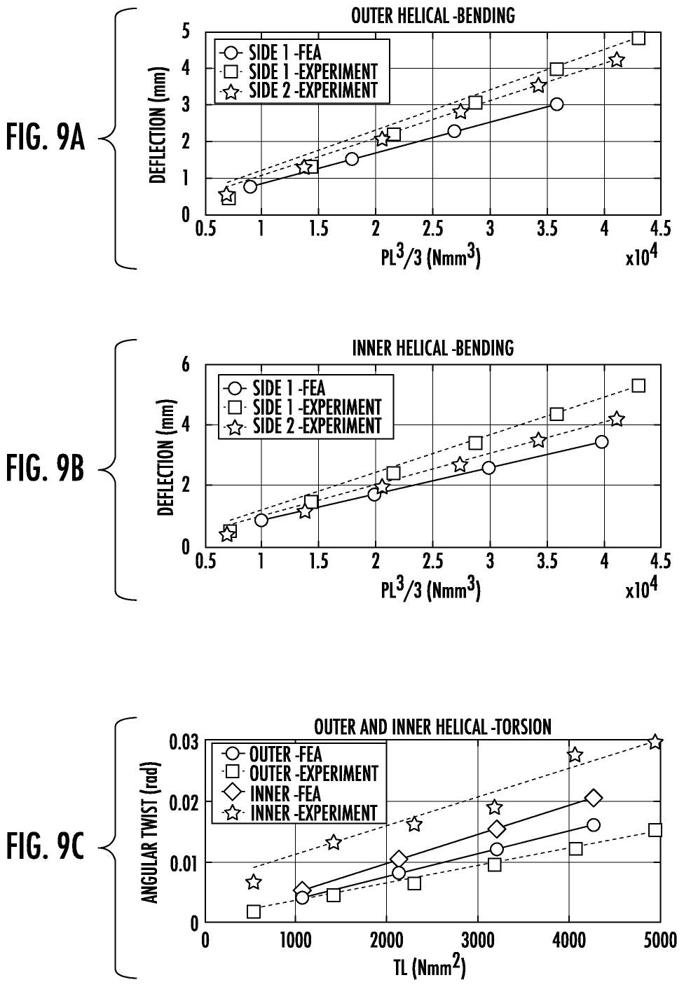

Angular twist φ versus TL was plotted for both revolute and helical designs in FIGS. 8C and 9C and a linear fit of the FEA angular twist and the experimental angular twist data was performed. The slope of these fitted lines correspond to 1/GJ, the inverse of the effective torsional rigidity (GJ).

For the physical experiment, an arm was rigidly attached to each bellows as shown in FIG. 7A. Masses of 10, 20, 30, 40, and 50 grams were placed at the end of the arm, which is 75 mm in length from the centerline of the bellows to the location of the loading mass. An aluminum tube was inserted through the center of each bellows prototype to eliminate bending. The FEA trials use a similar loading condition where moments of 0.0074, 0.0147, 0.0221, 0.0294 Nm were applied. The R-squared values for all torsional rigidity trials were greater than 0.97. The results for these loading cases are shown in FIGS. 8A-8C and 9A-9C.

### Calibration Results

Results of parameter characterization are illustrated below in Table III. In general, FEA predicted slightly stiffer flexural rigidity values and slightly less stiff torsional rigidity values than those that were experimentally determined. Experimentally determined EI values for side 1 of each design were expected to be lower since 3D printed parts typically have a lower flexural rigidity in the direction of print orientation, due to layer effects. Considering the uncertainties in 3D printed wall thickness, the range of uncertainty in Young's modulus, and the complexity of bellows geometry, FEA predicted reasonable bending and torsional rigidity values. Even though there is some error in the FEA predicted parameters, the accuracy is sufficient for using FEA as an initial design tool, while the more accurate experimentally calibrated parameters can be used for kinematic prediction and control as discussed below.

TABLE III
Parameters Identified From FEA and Experimental
Measurements for Revolute and Helical Bellows

| | | | EI (Nm²) | | GJ (Nm²) | | EI/GJ | |
|---|---|---|---|---|---|---|---|---|
| Bellow Type | | Side | FEA | Experiment | FEA | Experiment | FEA | Experiment |
| Revolute | Outer | Side 1 | 0.0032 | 0.0025 | 0.104 | 0.115 | 0.031 | 0.022 |
| | | Side 2 | 0.0085 | 0.0090 | | | 0.082 | 0.078 |
| | Inner | Side 1 | 0.0057 | 0.0035 | 0.235 | 0.215 | 0.024 | 0.016 |
| | | Side 2 | 0.0097 | 0.0097 | | | 0.041 | 0.045 |
| Helical | Outer | Side 1 | 0.0118 | 0.0081 | 0.300 | 0.322 | 0.039 | 0.025 |
| | | Side 2 | 0.0118 | 0.0093 | | | 0.039 | 0.029 |
| | Inner | Side 1 | 0.0101 | 0.0074 | 0.168 | 0.172 | 0.060 | 0.043 |
| | | Side 2 | 0.0101 | 0.0089 | | | 0.060 | 0.052 |

The EI/GJ ratios from the physical experiments ranged from 0.016 to 0.078 which is an order of magnitude lower than conventional methods for reducing this ratio based on laser cutting notches into metal tubes as shown above in Table I. As experimentally shown below, ratios this small can be considered effectively zero because they produce a concentric tube robot exhibiting essentially no torsional deformation or lag between the proximal and distal ends (i.e. actuator angles are transmitted down the length without loss, even to friction). Thus, kinematic models may be reasonably used that assume infinite torsional rigidity, and stable actuator operation may be achieved.

Embodiments of the present inventive concept will now be discussed where a prior torsionally-rigid concentric-tube kinematic modeling framework is generalized to account for concentric structures that can exhibit direction-dependent flexural rigidity, such as 3D printed bellows as discussed above.

Let m₁=[mₓ m_{y}]^{T}∈R² be the vector of the internal bending moment (about the x and y cross-sectional axes) carried by the i^{th} bellows expressed in a material reference frame attached to the i^{th} bellows. Let Oi be the angle relating the material frame of the i^{th} bellows to a common robot “backbone” reference frame (defined as a “Bishop frame” that is fixed at the robot base and slides along the backbone without torsional rotation). Assuming zero torsional deformation along the length of the bellows, θi is constant and equal to the axial rotation of the i^{th} bellows at its base. Then, a moment balance on a segment of n concentric bellows expressed in the common backbone frame yields:

$${\sum }_{i = 1}^{n} R ( {θ}_{i} ) {m}_{i} = 0 , \\ where \\ R ( {θ}_{i} ) = [ \begin{matrix}cos ( {θ}_{i} ) & - sin ( {θ}_{i} ) \\ sin ( {θ}_{i} ) & cos ( {θ}_{i} )\end{matrix} ] \qquad Eqn . ( 3 )$$

A linearly elastic constitutive law relates the internal bending moment to the change in curvature of each bellows as:

$$\begin{matrix}{m}_{i} = [ \begin{matrix}{EI}_{xx , i} & 0 \\ 0 & {EI}_{yy , i}\end{matrix} ] ( [ \begin{matrix}{u}_{x , i} \\ {u}_{y , i}\end{matrix} ] - [ \begin{matrix}{u}_{x , i}^{*} \\ {u}_{y , i}^{*}\end{matrix} ] ) \\ = {K}_{i} ( {u}_{i} - {u}_{i}^{*} )\end{matrix} \qquad Eqn . ( 4 )$$

where Kᵢ is the bending stiffness matrix; uᵢ is the curvature vector containing the pre-curvature components about the bellows' own x and y cross-sectional axes; and u*ᵢ is the initial pre-curvature vector of each bellows. It will be understood that the flexural rigidities within Kᵢ are allowed to be different in the x and y direction. The equilibrium curvature components in the robot backbone frame are then expressed as:

u=[uₓ,u_{y}]^{T}=R(θᵢ)uᵢ∀i Eqn. (5)

since the bellows must share a common curvature when expressed in the same reference frame. By substituting this into Eqn. (4), the result can be manipulated to obtain the equilibrium curvature vector:

$$u = {( {{\sum }^{n}}_{i = 1} R ( {θ}_{i} ) {K}_{i} {R}^{T} ( {θ}_{i} ) )}^{- 1} {\sum }_{i = 1}^{n} R ( {θ}_{i} ) {K}_{i} {u}_{i}^{*} \qquad Eqn . ( 6 )$$

The constant-curvature transformation matrix T(s) of the robot backbone frame along the arc-length s of a segment of overlapped bellows tubes with respect to its base is then computed as:

$$T ( s ) = {e}^{\hat{ξ} s} = [ \begin{matrix}R & P \\ {0}^{T} & 1\end{matrix} ] , \\ where \\ \hat{ξ} = [ \begin{matrix}0 & 0 & {u}_{y} & 0 \\ 0 & 0 & - {u}_{x} & 0 \\ - {u}_{y} & {u}_{x} & 0 & 1 \\ 0 & 0 & 0 & 0\end{matrix} ] \\ R ( s ) = [ \begin{matrix}\frac{{u}_{x}^{2} + {u}_{y}^{2} {C}_{β}}{{U}^{2}} & \frac{{u}_{x} {u}_{y} ( 1 - {C}_{β} )}{{U}^{2}} & \frac{{u}_{y} {S}_{β}}{U} \\ \frac{{u}_{x} {u}_{y} ( 1 - {C}_{β} )}{{U}^{2}} & \frac{{u}_{y}^{2} + {u}_{x}^{2} {C}_{β}}{{U}^{2}} & \frac{- {u}_{x} {S}_{β}}{U} \\ \frac{- {u}_{y} {S}_{β}}{U} & \frac{{u}_{x} {S}_{β}}{U} & {C}_{β}\end{matrix} ] \\ p ( s ) = {[ \begin{matrix}\frac{{u}_{y} ( 1 - {C}_{β} )}{{U}^{2}} & \frac{- {u}_{x} ( 1 - {C}_{β} )}{{U}^{2}} & \frac{{S}_{β}}{U}\end{matrix} ]}^{T} \qquad Eqn . ( 7 )$$

where U=the square root of (u2 x+u²_{y}) (the magnitude of curvature), β=sU (the total bending angle at s), and Cβ and Sβ are symbols that represent cos(β) and sin(β), respectively. It is understood that Eqn. (7) is written in terms of the Cartesian components of the curvature vector. This is equivalent to the commonly used constant-curvature transformation (which is expressed in terms of the polar angle and magnitude of the curvature vector) but Eqn. (7) has the advantage that it does not suffer from an artificial singularity in the straight configuration which is inherent to the polar representation.

If m segments exist in series, the transformation at the tip of the robot is then:

$${T}_{tip} ( s ) = {\prod }_{j = 1}^{m} {T}_{j} ( {l}_{j} ) \qquad Eqn . ( 8 )$$

where lj is the arc-length of the j^{t} segment. It will be understood that in embodiments including helical bellows pairs, the overlapped section length changes as a function of actuation angles due to the helical pitch of the bellows, and there is an additional segment at the tip in which only one bellows is present (in which case Eqn. (6) reduces to u=R(θi)u*i). In these embodiments including a pair of helical bellows tubes, the length of this additional segment 12 can be calculated as 12=h|θ2−θ1| where θ2 and θ1 are the outer and inner bellows base angles (defined such that θ2=θ1 when the bellows are fully overlapped) and h is the helical pitch of the bellows design. Depending on the handedness of the helix, and the direction of base rotation, the tip segment could consist of either the inner bellows or the outer bellows.

### Model Validation

Experimental validation of the model and comparison of the accuracy of the parameters calibrated will now be discussed.

### Actuation Setup

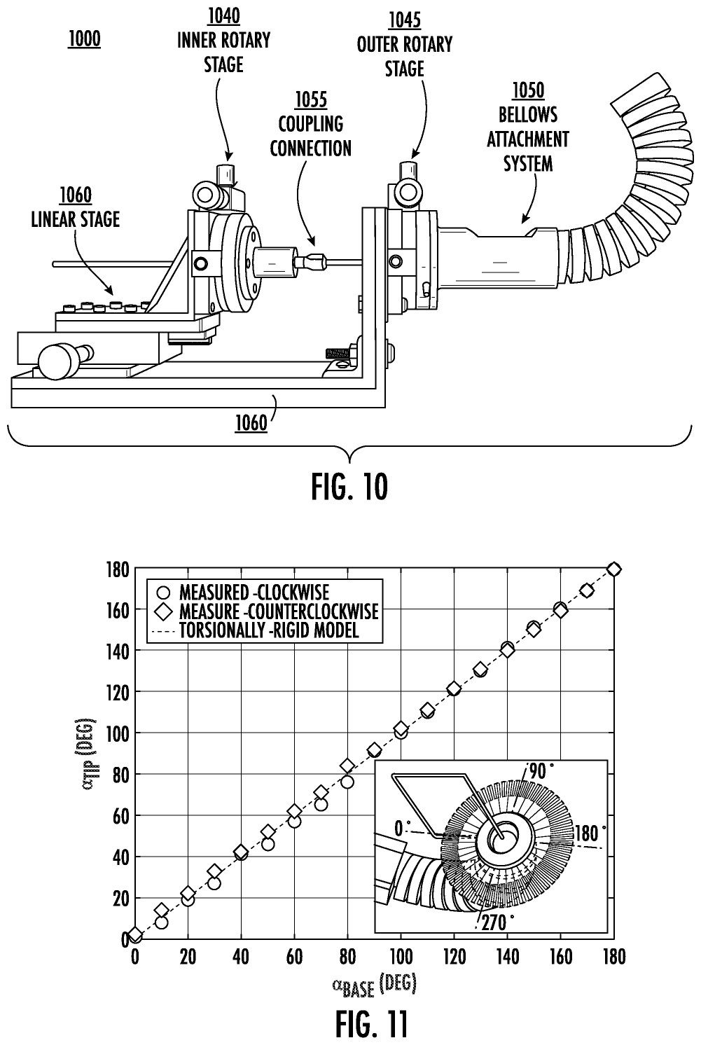

Referring to FIG. 10, a manual actuation system 1000 that enables rotation and translation of two concentric bellows will be discussed. As illustrated in FIG. 10, the system includes two rotary stages (Optics Focus MAR-60L-P), an inner rotary stage 1040 and an outer rotary stage 1045, which allow independent rotation of each bellows base with a micrometer for fine angular adjustments with a readable resolution of 0.083°. Because helical bellows require simultaneous rotation and translation with a specific pitch, a single dovetail linear stage (Optics Focus MDX-4090-60) 1060 was used to allow relative translation as the tubes are rotated. The linear stage 1060 has a track range of 70 mm which is enough to provide multiple revolutions. The inner bellows attached using a bellows attachment system 1050 to its outer rotary stage 1045 via a ⅛″ diameter steel rod that passes through the outer bellows stage. The outer rotary stage 1045 is coupled to the inner rotary stage 1040 using a coupling connection 1055. The entire assembly is supported by a rigid acrylic frame 1060. It will be understood that this system 1000 is provided as an example only and that embodiments of the present inventive concept are not limited to this configuration. Manual actuation of the system 1000 illustrated in FIG. 10 provides rotation for both the inner and outer bellows and allows translation of inner bellows.

### Validation of Torsionally Rigid Assumption

To validate the torsionally rigid model assumption (and the implication that friction does not affect the shape), the system is actuated over its entire workspace and the relative angle between the two bellows is measured at the segment tip αₜᵢₚ=θ2,ₜᵢₚ−θ1,ₜᵢₚ and this value is compared to the relative angle of the two bellows bases α_{base}=θ2,_{base}−θ1,_{base}. If the bellows pair exhibits torsional rigidity with no loss to friction, the tip angle should equal the base angle for all base rotations.

The inner bellows rotates through 180° in both clockwise and counter clockwise directions in 10° increments. A graduated disk with a resolution of 1° attached at the distal tip of the outer bellows, and a wire pointer attached to the inner bellows is used to indicate angle readings. Referring now to FIG. 11, a plot illustrating the angle between the inner and outer bellows at the tip over a range of relative base actuation angles is shown. Torsional rigidity would imply the base and tip angles to be equal (dashed line). Thus, the data confirms the torsionally rigid assumption in accordance with embodiments of the present inventive concept. The experimental setup is shown in the inset of FIG. 11. Thus, FIG. 11 shows the experimental setup and the results of this experiment. The maximum difference between actuated and measured tip twist angle was only 4′, which confirms the assumptions of torsional rigidity and negligible frictional effects by exhibiting substantially zero torsional lag.

### Kinematic Model Validation

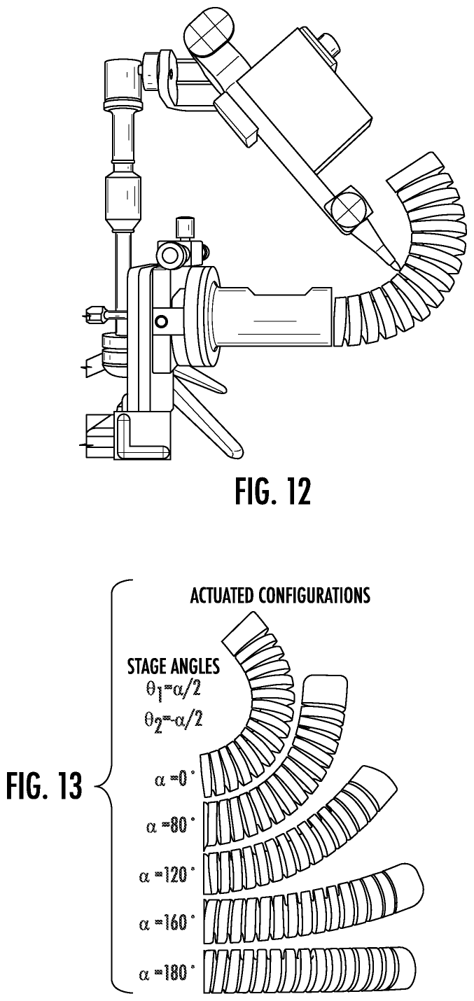

To validate the accuracy of the full kinematic model in accordance with embodiments discussed herein, the bellows pair is actuated by equal angles in opposite directions (i.e. θ1=α/2, θ2=−α/2 for relative input angles ranging from α=0′ (pre-curvatures aligned) to α=180′ (pre-curvatures diametrically opposed), which actuates the bellows from maximum curvature, to almost completely straight as shown in FIGS. 12 and 13. In particular, FIG. 12 illustrate an experimental setup for measuring points along the curvature of the bellows pair and FIG. 13 illustrates configurations of the bellows when measured in five configurations in which the angles of the inner and outer bellows were equal in magnitude but opposite in direction. The radii of pre-curvature for both bellows tubes are 0.055 m in the direction of side 1.

A stereoscopic camera (ClaroNav MicronTracker H3-60) was used along with a stylus pointer to measure points on the surface of the outer bellows. An adjustable desktop tripod with a camera mount attachment held the stylus pointer to provide reliable and steady measurements. The camera frame was rigidly registered to the robot base frame using a separate symmetric data sets using MATLAB's peregistericp( ) from the Camera Vision Toolbox. The repeatability of the actuation and measurement procedure was repeatedly evaluated by recording the distal tip position of the bellows coming from both α=0° and from α=180° configurations for the α=40°, α=60° and α=80° cases. Ten individual tip positions were taken at each configuration, with 5 from each direction. The largest standard deviation of tip position for each configuration was 0.7 mm.

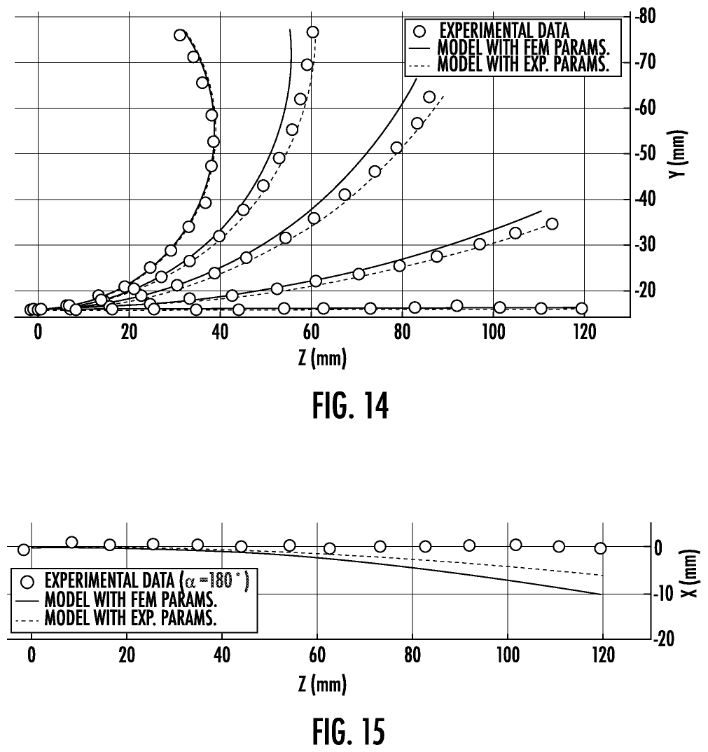

The experimental surface shape data is compared to predictions made by the kinematic model in FIGS. 14 and 15. In particular, FIG. 14 illustrates experimental measurements of helical bellows in actuated configurations in comparison with the torsionally-rigid kinematic model using FEA determined parameters and using experimentally determined parameters and FIG. 14 illustrates a side view of the out-of-plane error in the α=180° configuration. Two different kinematic model predictions are shown: (1) using the flexural rigidities calibrated from FEA simulations, and (2) using the flexural rigidities calibrated experimentally (which are direction-dependent). The root mean square error (RMSE) for both models is tabulated in Table IV below. The direction-dependent experimental calibration of flexural rigidity discussed above improves shape prediction accuracy versus the FEA calibrated parameters. The shape validation results additionally verify the assumption of torsional rigidity and the implication that frictional forces, while present, do not significantly affect the shape because of the high stiffness of the torsional transmission.

TABLE IV
Kinematic Modeling Error

| | | With |
|---|---|---|
| | With FEA | Experimental |
| | Parameters | Parameters |
| | RMSE | RMSE |
| Configuration | (mm) | (mm) |
| α = 0° | 1.28 | 1.28 |
| α = 80° | 2.30 | 1.12 |
| α = 120° | 3.89 | 1.99 |
| α = 160° | 4.28 | 2.72 |
| α = 180° | 4.27 | 2.78 |

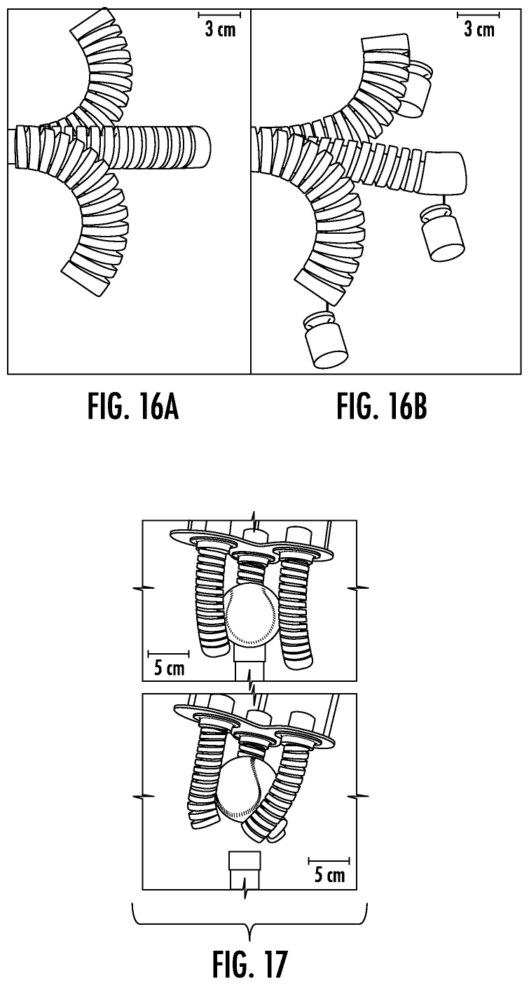

The results discussed herein demonstrate that a concentric pre-curved bellows pair is a can be used as an actuator. Whereas friction limits the kinematic accuracy and bending range of tendon/cable-driven continuum manipulators. As discussed herein, a concentric-bellows pair in accordance with embodiments discussed herein is largely unaffected by frictional forces at large bending angles due to the high torsional stiffness of the transmission. Fluid-driven and material-based actuation may entail other trade-offs in terms of actuation bandwidth and safety, for example, high pressures. To demonstrate payload capacity (and further confirm that friction does not hinder performance), FIGS. 16A and 16B illustrate a payload capacity of a helical concentric pre-curved bellows pair actuated with (16B) and without (16A) 100g tip load. FIG. 17 illustrates a soft gripper application. FIGS. 16A through 17 illustrate a bellows in accordance with embodiments discussed herein lifting a 100g tip load, which is four times the mass of the bellows pair, while mostly retaining its desired shape across the bending range. Payload capacity can be tailored to the application by selecting the wall thickness and other dimensions of the convolution geometry. In general, increasing the wall thickness increases the effective EI while minimally affecting EI/GJ, thus increasing payload capacity while maintaining robot performance and overall diameter. For example, doubling the wall thickness of the outer helical bellows to 0.6 mm increases EI by a factor of five while only increasing EI/GJ by 25% to 0.05.

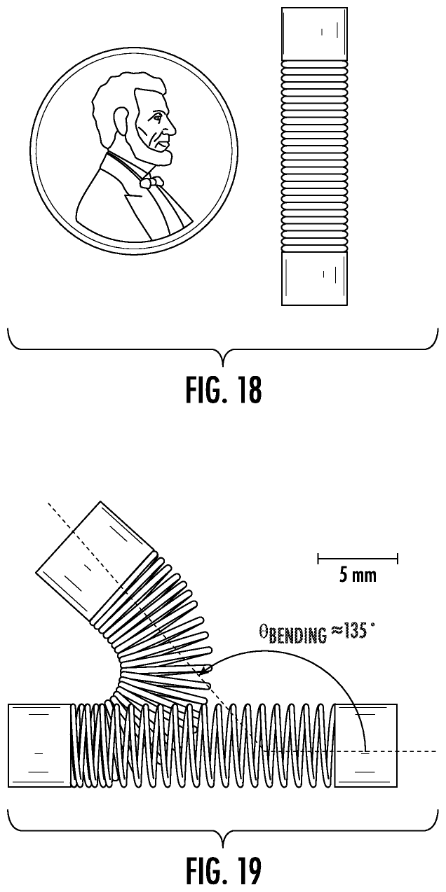

Applications of concentric-bellows actuation include manipulation tasks at scales appropriate for human cooperation. As a demonstration, a soft gripper using revolute bellows fingers that can grasp and lift a baseball (150g, 75 mm diameter) as shown in FIG. 17. It is also feasible to use concentric bellows actuation in surgical tools that require a high amount of angulation. For example, FIGS. 18 and 19 demonstrates a 5 mm diameter (relative to a penny) bellows precisely fabricated by nickel electro-forming, courtesy of Servometer, which is capable of at least a +135° degree bending range.

As discussed briefly herein, embodiments of the present inventive concept provide a concentric pre-curved bellows pair to be used as an actuator for, for example, soft robots or surgical tools. This actuation method provides good performance over large bending angles due to an EI/GJ ratio much lower than conventional strategies, possibly eliminating the issue of unstable snapping and allowing the use of constant-curvature kinematic models.

Although pre-curved concentric bellows actuators are discussed above as including two nested pre-curved, concentric bellows, embodiments of the present inventive concept are not limited to this configuration. Pre-curved, concentric bellows actuators may include more than two bellows as illustrated, for example, in FIG. 20. As illustrated in FIG. 20, the pre-curved, concentric combined bellows 104 includes three nested bellows 105, 106 and 107. Utilizing three bellows as illustrated in FIG. 20 may allow that actuator to control the axial angle of the tip as well as its position in space. It will be understood that more than three bellows may also be to achieve a chain of multiple independently controllable segments in series toward a highly articulated soft robotic arm, like a concentric-tube robot. Thus, the more bellows included in the actuator, the more granularity of control that may be gained. FIG. 21 is a diagram illustrating a cross-section of the combined bellows 104. As illustrated, the three bellows 105, 106 and 107 are nested inside one another.

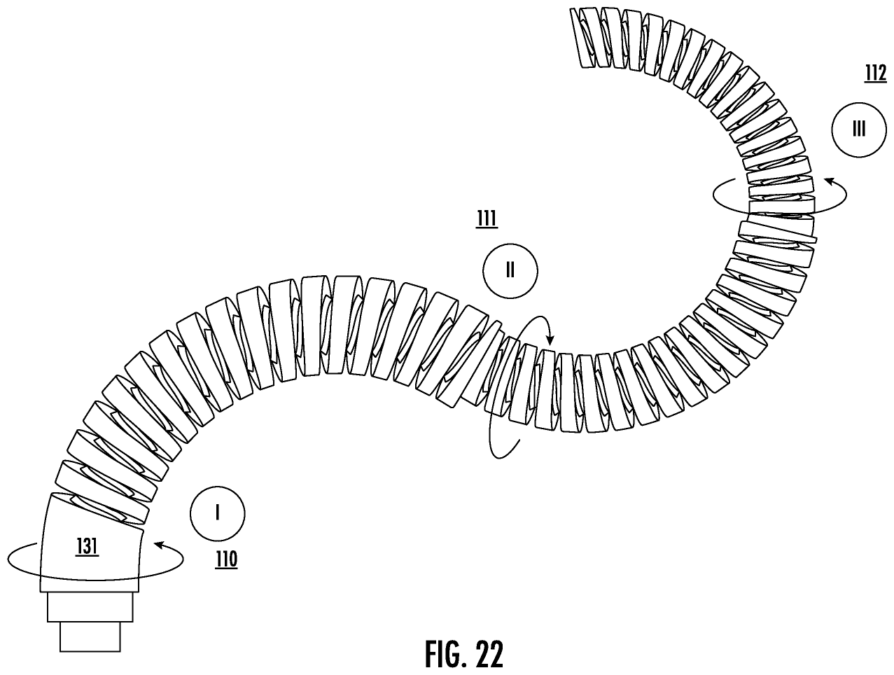

However, embodiments of the present inventive concept are not limited to two or three nested bellows. Any number of bellows may be combined to achieve more control. For example, six bellows may be combined to provide six degrees of freedom in some embodiments. Furthermore, bellows may be combined in a number of ways and are not limited to being nested as shown in FIGS. 20 and 21. For example, single bellows, bellows pairs, three bellows and the like may be connected end to end. An end to end configuration is illustrated, for example, in FIG. 22.

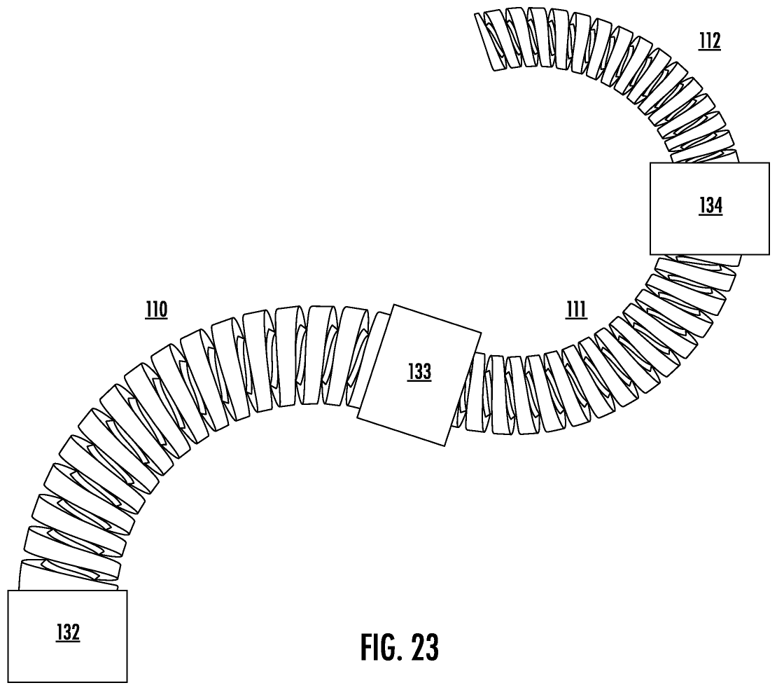

As illustrated in FIG. 22, three “bellows assemblies” 110, 111 and 112 are connected end to end. These “bellows assemblies” 110, 111 and 112 may be single bellows, bellows pairs or three or more bellows nested together. The plurality of bellows 110, 111 and 112 in FIG. 22 are coupled to a single drive mechanism (multiple motors) 131 at a base of the three bellows, however, embodiments of the present inventive concept are not limited to this configuration. For example, the plurality of bellows 110, 111, and 112 in FIG. 23 each have a drive mechanism 132, 133 and 134, respectively, at a base thereof. Thus, the bellows assemblies may be activated by one or more motors associated therewith and positioned therebetween without departing from the scope of the present inventive concept.

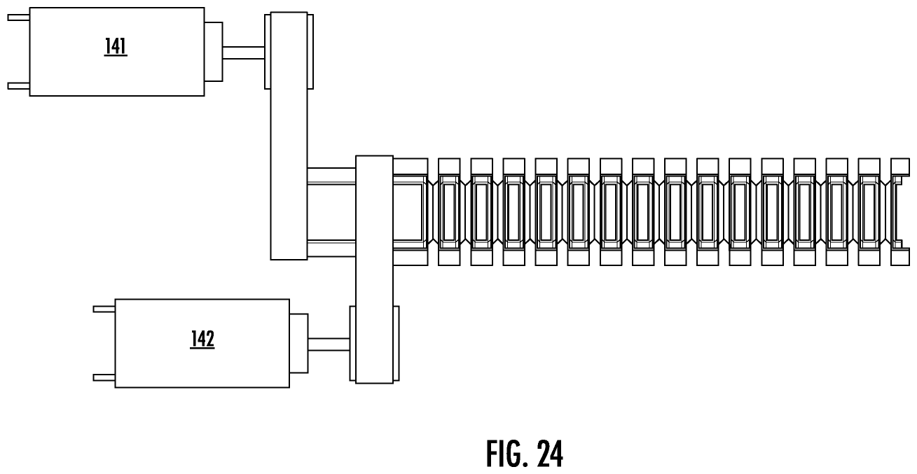

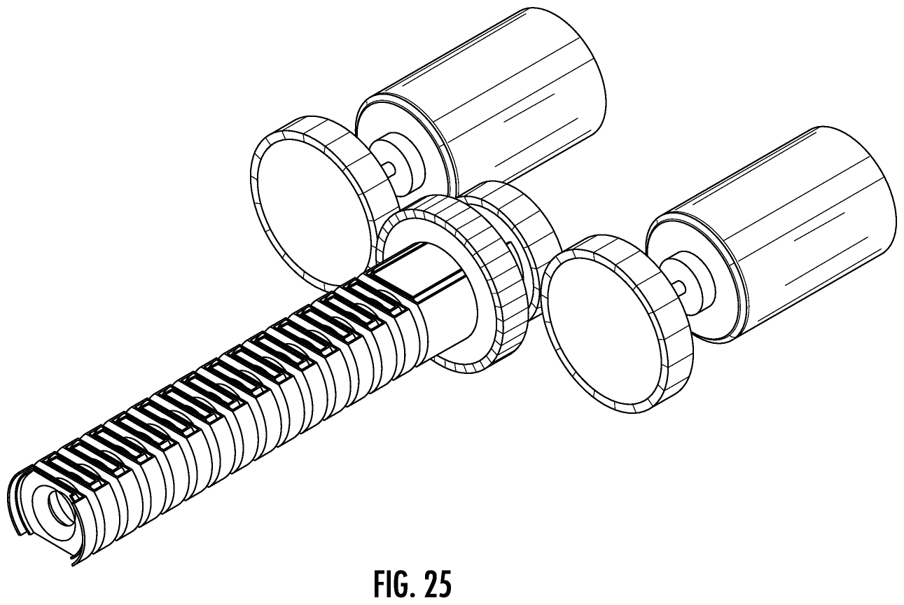

In particular, FIG. 24 is a diagram of bellows having a plurality of motors 141 and 142 at a base of the bellows. Thus, each of the motors 141 and 142 may activate a single bellows, bellows pair or a combined three or more bellows as discussed above. FIG. 25 illustrates another example configuration of bellows and motors in accordance with embodiments of the present inventive concept.

Thus, as discussed above, bellows, bellows pair and a combined three or more bellows may be combined with one or more motors to provide a series of “bellows” together with their activating motors to create, for example, an articulated arm of a robot in accordance with some embodiments discussed herein.

Although embodiments of the present inventive concept are discussed above as having a circular pre-curved arc, it will be understood that embodiments of the present inventive concept are not limited to this configuration. For example, the pre-curved shape of the bellows can be any type of curve without departing from the scope of the present inventive concept.

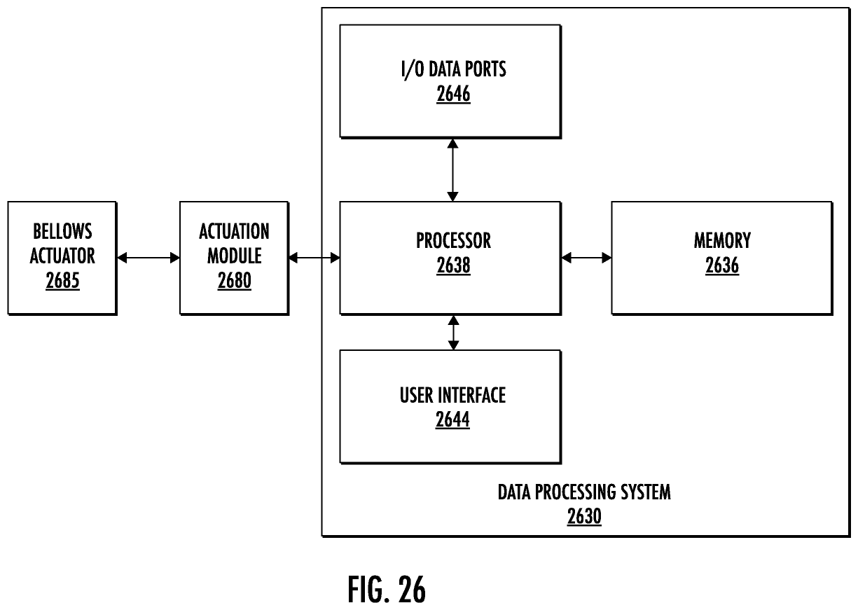

Embodiments discussed above are discussed with respect to manual manipulation of the concentric, pre-curved bellows pair to actuate the device. However, embodiments of the present inventive concept are not limited to this configuration. For example, in some embodiments the mechanical actuator discussed herein may be remotely manipulated using signals applied to the mechanism from a remote location and/or automatically manipulated based on a preconceived program delivered to the mechanism. In these embodiments, the mechanical actuator in accordance with embodiments discussed herein includes an actuation module that is operated responsive to signals received from a data processing system as will be discussed below with respect to FIG. 26. The data processing system 2630 of FIG. 26 may be included anywhere in the system in which the device controlled by the bellows actuator 2685 in accordance with some embodiments of the present inventive concept is positioned. For example, the data processing system 2630 may be positioned remote from the device, for example, robot controlled by the bellows actuator 2685. The actuation module 2680 may receive instructions from the remote location and provide those instructions to the bellows actuator 2685. The instructions provided may cause the bellows actuator to move in some desired configuration. As discussed above, the remote instructions may be supplied by a person at the remote location or may be preprogrammed for the bellows actuator 2685 without departing from the scope of the present inventive concept. Exemplary embodiments of a data processing system 2630 configured in accordance with embodiments of the present inventive concept will be discussed with respect to FIG. 26. The data processing system 2630 may include a user interface 2644, including, for example, input device(s) such as a keyboard or keypad, a display, a speaker and/or microphone, and a memory 2636 that communicate with a processor 2638. The data processing system 2630 may further include I/O data port(s) 2646 that also communicates with the processor 2638. The I/O data ports 2646 can be used to transfer information between the data processing system 2630 and another computer system or a network using, for example, an Internet Protocol (IP) connection. These components may be conventional components such as those used in many conventional data processing systems, which may be configured to operate as described herein.

It will be understood that actuation devices discussed herein may include rotation as well as translation, depending on the geometry of the bellows. Accordingly, when the term rotation is used when referring to actuation, translation may be involved in some embodiments. The data processing system 2630 may be used in these processes.

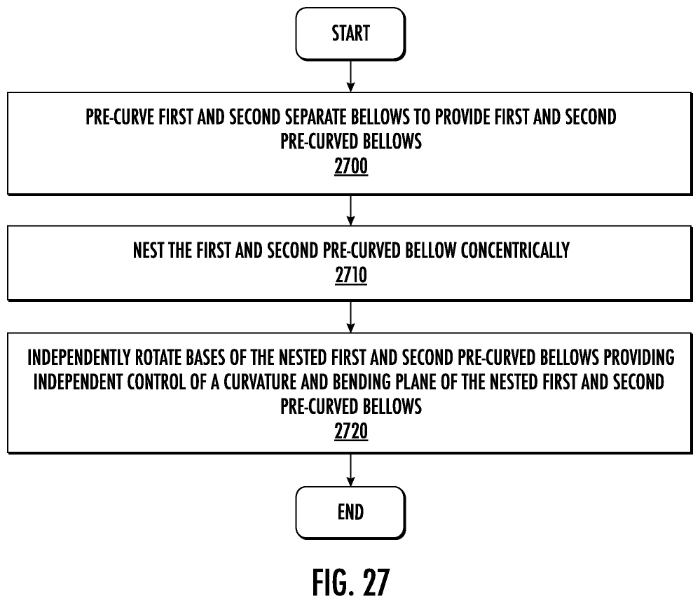

Referring now to FIG. 27, methods for constructing and actuating a robot in accordance with some embodiments of the present inventive concept will be discussed. It will be understood that the method of FIG. 27 is directed to embodiments having two nested bellows. However, as discussed above, embodiments of the present inventive concept are not limited to two bellows. The method may be adjusted to add additional bellows as needed. As illustrated in FIG. 27, operations begin at block 2700 by pre-curving first and second separate bellows to provide first and second pre-curved bellows. As discussed above, the bellows may be pre-curved by inserting a jig and heating the combination of bellows and jig. Once the heat is removed and the bellows cools, the jog can be removed. Once the first and second bellows have been pre-curved, the first and second pre-curved bellows may be concentrically nested (block 2710). As discussed above, in embodiments using revolute bellows, the bellows may have to be made interconnected rather than put together once the bellows are printed. Once the pre-curved bellows are nested, one inside the other, they can be independently rotated at their individual bases to provide independent control of a curvature and bending plane of the nested first and second pre-curved bellows (block 2720).

In some embodiments, axially rotating the bases of each of the first and second pre-curved bellows in equal amounts in opposite directions to change a bending angle in a single plane. Similarly, axially rotating the bases of each of the first and second pre-curved bellows in equal amounts in a same direction to change a plane of bending. The inner bellows can be rotated through 180° in both clockwise and counter clockwise directions in 10° increments.

As discussed above, this bellows actuator has a ratio of EI/GJ, flexural rigidity (EI) to torsional rigidity (GJ), that is less than 0.08. See Table I. Thus, the nested bellows actuator may not experience any torsional lag during rotation of the bases of the nested first and second pre-curved bellows.

As discussed briefly above, two types of 3D printed concentric pre-curved bellows are discussed, revolute and helical. As discussed above, some embodiments provide a mechanical actuator that virtually eliminates the snapping issue with conventional nested tubes and may provide actuators for devices in need of actuators have greater than a 5 mm diameter. Bellows pairs in accordance with embodiments discussed herein may be scaled up to much larger diameters than the conventions nested tubes.

As discussed above, some embodiments of the present inventive concept discuss a mechanical bending actuator for soft and continuum robots based on concentric pre-curved bellows. These actuators consist of at least two bellows tubes that have a pre-curved shape and are nested concentrically within one another. Independent axial rotations of each bellows tube changes the curvature and bending plane of the combined bellows pair. While bellows are traditionally used as a pneumatic expansion element, embodiments discussed herein use bellows as a mechanical element that enables bending actuation for soft and continuum robots.

As will be appreciated by one of skill in the art, the inventive concept may be embodied as a method, data processing system, or computer program product. Accordingly, the present inventive concept may take the form of an entirely hardware embodiment or an embodiment combining software and hardware aspects all generally referred to herein as a “circuit” or “module.” Furthermore, the present inventive concept may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present inventive concept may be written in an object-oriented programming language such as Java®, Smalltalk or C++. However, the computer program code for carrying out operations of the present inventive concept may also be written in conventional procedural programming languages, such as the “C” programming language or in a visually oriented programming environment, such as VisualBasic.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The inventive concept is described in part above with reference to a flowchart illustration and/or block diagrams of methods, systems and computer program products according to embodiments of the inventive concept. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. A mechanical bending actuator comprising:
a first concentric, pre-curved bellows; and
a second concentric, pre-curved bellows nested inside the first concentric, pre-curved bellows to provide a concentric, pre-curved bellows pair that when rotated axially at a base of the first and/or second concentric, pre-curved bellows provides independent control of a curvature and bending plane of the concentric, pre-curved bellows pair.

2. The mechanical bending actuator of claim 1, wherein a ratio of EI/GJ, flexural rigidity (EI) to torsional rigidity (GJ), of the first and/or second concentric, pre-curved bellows is less than 0.08.

3. The mechanical bending actuator of claim 2, wherein the mechanical bending actuator exhibits substantially zero torsional lag during actuation.

4. The mechanical bending actuator of claim 1, wherein a diameter of the concentric, pre-curved bellows pair is greater than 5 mm.

5. The mechanical bending actuator of claim 1, wherein rotation of the base of the first and second concentric, pre-curved bellows in equal amounts in opposite directions changes a bending angle in a single plane.

6. The mechanical bending actuator of claim 1, wherein rotation of the base of the first and second concentric, pre-curved bellows in equal amounts in a same direction changes a plane of bending.

7. The mechanical bending actuator of claim 1, wherein the concentric, pre-curved bellows pair is one of a helical bellows and a revolute bellows.

8. The mechanical bending actuator of claim 1, wherein the mechanical actuator is used in one of soft robots and medical tools.

9. A system for actuating a soft robot comprising:
a pre-curved, concentric bellows actuator, the pre-curved concentric bellows actuator including at least two concentric, pre-curved bellows, the at least two concentric pre-curved bellows comprising a first concentric, pre-curved bellows and a second concentric, pre-curved bellows coupled to the first concentric, pre-curved bellows; and
an actuation module coupled to the pre-curved, concentric bellows actuator and configured to provide instructions to the pre-curved, concentric bellows actuator to rotate axially at a base of the first and/or second concentric, pre-curved bellows to provide independent control of the system.

10. The system of claim 9, wherein the pre-curved, concentric bellows actuator further comprises a third concentric, pre-curved bellows coupled to the first and second concentric, pre-curved bellows.

11. The system of claim 9, wherein the system further comprises a plurality of pre-curved, concentric bellows actuators, the plurality of pre-curved, concentric bellows actuators being nested inside one another and/or coupled end to end.

12. The system of claim 11, wherein the plurality of pre-curved, bellows actuators are each actuated individually using a dedicated drive mechanism associated with each of the plurality of pre-curved, bellows actuators, respectively, or actuated using a single drive mechanism associated with all of the plurality of pre-curved, concentric bellows actuators.

13. The system of claim 11, wherein at least one of the plurality of pre-curved, concentric bellows actuators includes more than two bellows therein.

14. The system of claim 9, wherein the system further comprises at least one pre-curved, concentric bellows actuator and at least one single pre-curved bellows, the at least one pre-curved concentric bellows actuator and the at least one single pre-curved bellows being nested inside one another and/or coupled end to end.

15. A method for constructing and actuating a robot comprising:
pre-curving first and second separate bellows to provide first and second pre-curved bellows;
nesting the first and second pre-curved bellows concentrically; and
independently rotating bases of the nested first and second pre-curved bellows providing independent control of a curvature and bending plane of the nested first and second pre-curved bellows.

16. The method of claim 14 further comprising axially rotating the bases of each of the first and second pre-curved bellows in equal amounts in opposite directions to change a bending angle in a single plane.

17. The method of claim 15 further comprising axially rotating the bases of each of the first and second pre-curved bellows in equal amounts in a same direction to change a plane of bending.

18. The method of claim 15, wherein a ratio of EI/GJ, flexural rigidity (EI) to torsional rigidity (GJ), of the nested first and second pre-curved bellows is less than 0.08.

19. The method of claim 15 further comprising experiencing no torsional lag during rotation of the bases of the nested first and second pre-curved bellows.

20. The method of claim 15, wherein a diameter of the first and second pre-curved bellows is greater than 5 mm.

21. The method of claim 15, wherein each of the first and second pre-curved bellows is one of a helical bellows and a revolute bellows.
